(19) United States
(12) Patent Application Publication
(10) Pub. No.: US 2008/0269431 A1
(43) Pub. Date: Oct. 30, 2008

(54) Apparatus and Method for Continuously Carried Out Equilibrium Reactions

(75) Inventors: Dirk Sarcinelli, Buettelborn (DE); Hermann Siegert, Seeheim-Jugenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK ROEHM GMBH, DARMSTADT (DE)

(21) Appl. No.: 11/995,206

(22) PCT Filed: Aug. 16, 2006
(86) PCT No.: PCT/EP06/65336

§ 371 Date: Jan. 10, 2008

(30) Foreign Application Priority Data
Sep. 13, 2005 (DE) 10 2005 043 719.2

(51) Int. Cl. C08F 2/01; C08G 69/02; C08G 63/02

(52) U.S. Cl. 526/64; 528/332; 528/271

(57) ABSTRACT

The invention relates to an apparatus and a process for carrying out equilibrium reactions continuously.

The invention relates to an apparatus and a process for carrying out equilibrium reactions continuously.

If various products are to be produced in one plant, plants operated batchwise are used virtually exclusively. On the other hand, a continuously operating plant offers some significant advantages over a batch process.

The outlay for instrumentation is lower, the personnel requirement is lower, the product quality is better and fluctuates less, the plant capacity is increased because the sequential working through the individual process steps (charging, reaction, removal of low boilers, isolation of product, emptying) is dispensed with.

In the case of equilibrium reactions, specific processes have been developed in order to make it possible for the equilibrium to be shifted in the desired direction.

Most reaction equations are equilibrium reactions with a low enthalpy of reaction. In U.S. Pat. No. 3,836,576, for example, a reaction is carried out in the presence of the corresponding alcohol titanate as a homogeneously catalysed reaction. To suppress undesirable polymerization reactions, an inhibitor (e.g. hydroquinone monomethyl ether) is added to the reaction mixture. To shift the equilibrium position of the reaction in the direction of the products and thus to increase the reaction rate, the low-boiling alcohol liberated in the reaction is removed from the reaction mixture by distillation and separated off from the other reaction components by means of a distillation column. As an alternative, the separation, in the case of a reactive distillation, occurs within the reaction space. Reactive distillations are described in EP 0968995.

However, the literature (e.g. U.S. Pat. No. 3,887,609) describes mainly batch processes, in particular processes using new types of catalyst systems.

GB 841416 describes a stirred vessel with a downstream reactor containing deflection plates over which the reaction mixture is passed. Here, the starting materials are premixed in a stirred vessel and the reaction is started. For the further reaction, the reaction mixture can be introduced into the downstream reactor. However, to achieve better results, a spiral reactor is recommended in order to improve, for example, the heat transfer. The arrangement of the deflection plates described in GB 841416 leads to a fixed, no longer variable reaction volume. In addition, dead zones can be formed at the deflection plates and lead to undesirable polymerization reactions. Likewise, suspensions comprising, for example, catalysts can be transported less readily. A further problem is backmixing. This has an adverse effect on the product quality.

EP 0968995 describes the continuous preparation of alkyl methacrylates in a reaction column. Here, the transesterification reaction occurs directly in a distillation column. In this way, higher reaction rates, higher conversions and selectivities and improved energy utilization compared to conventional batch transesterification processes are realised. However, no process steps for recycling the unreacted starting materials and for isolating purified product are indicated. Furthermore, coupling of reaction and materials separation leads to a significant restriction of the flexibility in terms of a multiproduct plant. The plant then has to be designed in a manner specific to the product.

It was an object of the invention to develop a process which makes it possible to achieve virtually complete conversion of the starting materials used, in particular the starting materials which are difficult to separate off from the product stream, combined with a high space-time yield in a continuous process.

A further object was to provide a suitable apparatus for carrying out the process which ensures a product change without out-of-specification material.

This object has been achieved by a process for the continuous preparation of products from equilibrium reactions, characterized in that the starting materials are fed to a segmented reactor (known as a compartment reactor) either via a rectification column or directly, in that the temperature is regulated by introduction of a starting material into individual segments of the compartment reactor, the reaction is accelerated, if appropriate, by the addition of catalysts and the product mixture is discharged together with unreacted starting materials and catalyst. At the same time, by-products can also be discharged from the process.

A process for the continuous preparation of products from equilibrium reactions, characterized in that, for the reaction of (meth)acrylates with alcohols or amines, the starting materials are fed to a compartment reactor either via a rectification column or directly, with the temperature being regulated via the introduction of (meth)acrylate into individual segments, the reaction is accelerated, if appropriate, by the addition of catalysts and the product mixture is discharged together with unreacted starting materials and catalyst, is thus also provided.

The expression (meth)acrylate here refers both to methacrylate, e.g. methyl methacrylate, ethyl methacrylate, etc., and to acrylate, e.g. methyl acrylate, ethyl acrylate, etc.

A significantly greater flexibility compared to conventional reactive distillation has surprisingly been found, since materials separation and reaction can be decoupled from one another. In addition, the process of the invention also makes a free choice of catalyst possible; for example, it allows the use of heterogeneous catalysts.

It has surprisingly been found that a product change without out-of-specification material can be achieved by stopping the flow of one starting material, flushing the reactor with a second starting material and subsequently changing to a new starting material. A product change without out-of-specification material can preferably be achieved in the reaction of (meth)acrylates with alcohols or amines by stopping the starting alcohol or amine flow, flushing the reactor with (meth)acrylates and subsequently changing to a new starting alcohol or a new starting amine.

It has been found that a starting material can be taken off as a side stream from the rectification column and be introduced in a targeted manner into the individual segments to regulate the temperature. In the reaction of (meth)acrylates with alcohols or amines, the (meth)acrylate can preferably be taken off as side stream from the rectification column and introduced in a targeted manner into the individual segments to regulate the temperature.

In one of the parent reaction equations, (meth)acrylates (C) or (meth)acrylamides (F) are prepared by continuous reaction of methyl (meth)acrylate (A) with alcohols (B) or amines (E) with liberation of methanol (D):

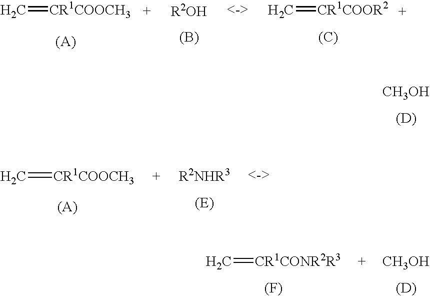

where R¹=H or CH₃ and R², R³ are identical or different linear, branched or cyclic alkyl radicals or aryl radicals or if appropriate alkoxy radicals having from 2 to 100 carbon atoms. When primary amines are used as starting material, R³ is hydrogen.

Possible alcohols R²OH are, for example, ethanol, propanol or isopropanol, butanol or isobutanol, pentanol, cyclohexanol or hexanol, heptanol, octanol or isooctanol and 2-ethylhexanol, and also diols and triols. Furthermore, it is possible to use isoborneol, benzyl alcohol, tetrahydrofurfurol, allyl alcohol, ethylene glycol, 3,3,5-trimethylcyclohexanol, phenylethanol, 1,3-butanediol, 1,4-butanediol, ethylene glycol, trimethylolpropane, various polyethylene glycols, tert-butylaminoethanol, diethylaminoethanol, ethyl triglycol, butyl diglycol, methyl triglycol or isopropylideneglycerol as alcohols. The alcohols used as starting materials can contain further functional groups.

The amines used as starting materials can contain further functional groups in addition to the primary or secondary amino group. Amines having two or more primary or secondary amino groups give the corresponding bis(meth)acrylamides, tris(meth)acrylamides or higher (meth)acrylamides. The amines can also contain one or more tertiary amino groups, hydroxy groups, thiol groups, ether groups or thioether groups. For example, a hydroxy group present can react with a further molecule of (meth)acrylate by transesterification.

Preference is given to using a tertiary aminoalkylamine of the general formula H₂N—R—NR′R″, where R is preferably a straight or branched chain having from 2 to 4 carbon atoms and R′ and R″ are identical or different alkyl groups which have from 1 to 8 carbon atoms, preferably from 1 to 4 carbon atoms, or, together with the tertiary nitrogen atom, are derived from a piperidino, morpholino or piperazino group, as amine. Particular preference is given to using gamma-dimethylaminopropylamine.

Apart from the reactions indicated, further equilibrium reactions such as esterifications can also be used as a basis.

In addition, simple adaptation of the production output by alteration of the reaction volume and simultaneous adaptation of the starting material streams is particularly advantageous. There is no fixed size of the reaction volume as in conventional processes as described, for example, in GB 841416.

The variation of the reaction volume is realised by means of openings in the segment walls below the liquid surface. Drilled holes in the segment walls are preferably utilized for transport of starting material/product into the adjacent segment. These openings can be located at any position, preferably in the lower third, on the segment wall. They are preferably arranged alternately in order to ensure optimal mixing in the segments. The starting material/product stream therefore does not have to be conveyed over the divisions. The apparatus of the invention therefore has no limiting influence on the size of the reaction space.

It has surprisingly been found that the phenomenon of backmixing between the segments can be prevented. The experimentally determined concentration profile corresponds virtually exactly to that of a calculated ideal cascade of vessels. Thus, backmixing occurs only within the segments. Such a process is a prerequisite for a rapid product change without out-of-specification material. Furthermore, high conversions can be achieved in this way. In addition, the use of stirrers in the individual segments can be dispensed with.

The temperature in the reactor can be controlled by precise metering of the starting material stream. The starting materials can be added in preheated form.

In a particularly preferred embodiment a temperature-regulated (meth)acrylate distribution is used. (Meth)acrylate is metered into individual segments. The temperature profile which is optimally matched to the product leads to achievement of the best possible reaction rate and thus to high space-time yields. The temperature-regulated introduction results in considerable simplification of the reactor control and the operation of the plant. The constant temperature profile leads to constant production conditions, which has a positive effect on the product quality. In combination with the stream taken off at a side offtake, the amount of, for example, methyl methacrylate available for temperature regulation can be increased.

The starting alcohol or the starting amine is advantageously introduced via a rectification column. In this way, impurities present in the starting material, e.g. water, can be separated off before the reaction in the compartment reactor.

It has surprisingly been found that a large number of vessels can be realised in a simple and inexpensive manner by means of the apparatus of the invention. The segmentation of the reactor leads to division of the reactor into many small segments. Each segment is separated from the next segment by segmentation walls and thus behaves as an individual reactor. The arrangement of many segments, corresponding to small reactors, in series within a reactor has many advantages. The number of segments enables, for example, the conversion to be controlled. The space-time yield can be increased while the final conversion remains constant by increasing the number of segments. A plurality of segments are utilized for a very complete conversion. In contrast thereto, the number of segments can be reduced in the case of products for which low conversions are desired. This is the case, for example, when the products tend to polymerize. In this way, tailored ways of carrying out the reaction can be realised at low volume-specific capital costs.

A particular embodiment makes it possible for the segment size to be varied. The segment size advantageously decreases within the reactor, since, for example in the case of catalysed reactions, the catalyst would be flushed too quickly from the first segment into the next segment by the runback from the rectification column flowing into the first segment. For other reactions, identical segment sizes can be advantageous.

The segment walls can be produced from various materials. Depending on the starting materials/products produced, materials such as glass, steel, ceramic, etc., can be used for the segment walls and the reactor. Metal sheets (deflection plates) are particularly advantageous for the segment walls since they are simple to work.

The deflection plates are not connected in a gastight manner to the reactor wall. The deflection plates are advantageously so high that gas can still be taken off above them from the segments and passed to the rectification column.

The apparatus of the invention has a geometry which minimizes dead zones. Undesirable polymerization reactions of the starting materials and products are virtually ruled out in this way.

The apparatus of the invention can be heated or cooled by means of conventional heating/cooling facilities such as jacket heating.

In a particularly preferred embodiment, the compartment reactor is equipped with heating coils. This makes optimal heat input possible. The heating coils can be passed through individual segments or through all segments. The introduction of a rapidly vaporizing starting material leads to very good mixing as a result of the formation of bubbles of vapour. If necessary, fresh starting material is introduced into the individual segments to regulate the temperature. Starting materials which can be separated off easily (e.g. (meth)acrylic esters) are preferably introduced here. As an alternative, conventional temperature regulation facilities can also be used. For example, the compartment reactor can also be operated under superatmospheric pressure.

The apparatus of the invention also comprises a rectification column. It is advantageous to use a column whose separation power is independent of the throughput through the column. This makes variable vaporization performances possible. The column particularly advantageously allows the starting material used for temperature regulation to be taken off in virtually pure form. As a result, the runback from the column into the reactor (the first segment) can be reduced and flushing effects can thus be decreased. Furthermore, the reaction temperature in the first segments of the reactor can be regulated in a broader range and better matching of the temperature profile can thus be achieved.

It has been found that heterogeneous catalysts, which are frequently used in the preparation of esters, can be removed from the reaction mixture with minimal outlay. In the apparatus of the invention, the catalysts are conveyed together with the reaction mixture through the reactor and are discharged with the product at the end and filtered off. In the case of a homogeneously catalysed reaction, the catalyst can be removed from the mixture without problems by means of precipitation reactions in a downstream work-up step. Unreacted starting materials can be separated off from the product mixture by distillation (column, thin film evaporator) and, if appropriate, fed back into the process.

It has surprisingly been found that rapid product changes without out-of-specification material are possible using the apparatus of the invention. The stopping or shutting-off of the starting alcohol or amine feed enables the reactor to be flushed with (meth)acrylate. As a result, only one starting material remains in the reactor. The decrease in concentration of the resulting product which is discharged can be monitored by measurement of various process parameters, e.g. on-line analysis, temperature. The change to a new starting alcohol or a new starting amine can then be effected directly. As a result, costs and time for a product change are minimized.

It has surprisingly been found that particularly pure products can be prepared by the process of the invention. In some equilibrium reactions, Michael addition products are formed as by-products. For example (meth)acrylates are prepared by continuous reaction of methyl (meth)acrylate with alcohols with liberation of methanol. 1.25-1.6% of Michael addition products are usually found in the product. The proportion of Michael addition products is reduced to less than 1%, preferably <0.5%, by means of the process of the invention.

The apparatus of the invention advantageously has a gradient of 2-10°. This simplifies transport of material from one segment into the next. In addition, no pumps are necessary.

A particular embodiment of the process of the invention allows the continuous reaction of (meth)acrylates with various alcohols or amines for which a high alcohol or amine conversion is required.

The (meth)acrylates and (meth)acrylamides prepared by the process of the invention have a very low residual content of starting materials which are difficult to separate off. Alcohols or amines can be used for the reaction. In addition, undesirable further reactions (e.g. polymerizations) are minimized in the process of the invention. Monoesters, diesters, triesters or higher esters can also be prepared using various catalysts.

The crude product can be purified further by means of a downstream thin film evaporator. In the preparation of distillable products by homogeneous catalysis, the product can be separated from the catalyst by distillation, e.g. by means of a thin film evaporator, and can be recirculated to the process.

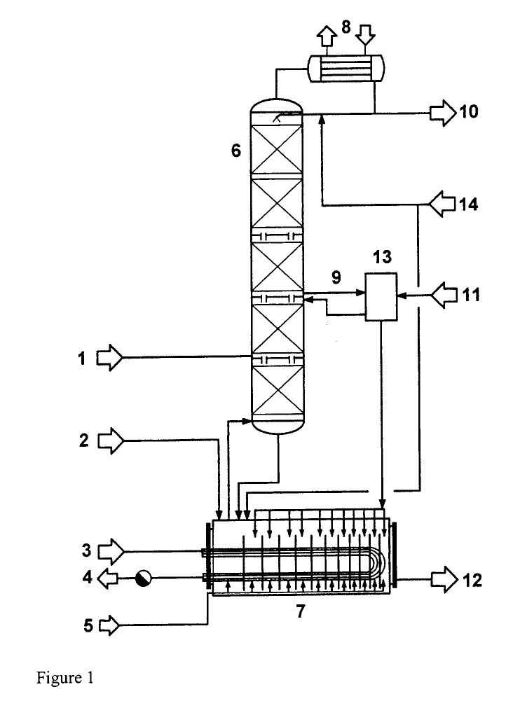

A particularly preferred embodiment of the compartment reactor is shown in FIG. 1.

### LEGEND FOR FIG. 1

1 Alcohol or amine feed
2 Catalyst feed
3 Introduction of steam
4 Discharge of condensate
5 Introduction of air
6 Rectification column
7 Compartment reactor
8 Condenser with cooling water inlet and outlet
9 Methyl (meth)acrylate taken off as a side stream
10 Discharge of methanol/methyl (meth)acrylate azeotrope
11 Methyl (meth)acrylate feed line
12 Discharge of crude ester
13 Buffer vessel for methyl (meth)acrylate
14 Addition of stabilizer

The process of the invention and the apparatus are illustrated by the following examples, without being restricted thereto.

The examples presented were carried out in a semi-technical experimental plant which is described below. The make-up of the experimental plant corresponds to the embodiment shown schematically in FIG. 1.

As reaction apparatus (7), use is made of a segmented reactor (compartment reactor) which is heated by means of steam via coils, is not mechanically stirred and has a variable fill volume. The compartment reactor is connected via a vapour line to a distillation column (6) mounted above it. The rectification column (pressure at the top=1 bar_{abs}) is provided with metal wire mesh packing.

The column is divided into two regions. In the upper segment, the overhead product is enriched in the low-boiling reaction product (10), which is usually obtained as an azeotrope, and the starting material used for regulation of the temperature is at the same time obtained in virtually pure form via the side offtake stream (9). The lower segment serves to remove low-boiling impurities (catalyst poisons) from the alcohol/amine (1) and prevents high boilers from reaching the upper segment. The alcohol/amine can optionally also be fed directly into the reactor. The starting material taken off as side stream (9) is fed via a buffer vessel (13) to the individual segments in a temperature-regulated fashion so that the desired temperature profile is established in the reactor. If the amount taken off as side stream is not sufficient, the regulation of the temperature is additionally effected automatically by means of fresh starting material (11). To inhibit polymerization reactions, air (5) was introduced into the individual segments. Furthermore, a polymerization inhibitor (14) dissolved in the starting material was introduced at the top of the column or directly into the reactor. The catalyst (2) necessary for the reaction was introduced in the form of a solution in the starting material into the first segment. The following examples are standardized to a reaction volume of 100 l. The composition of the streams (MMA content, alcohol content, MeOH content and product ester content) was determined by means of a gas chromatograph.

### EXAMPLE 1

### Continuous Preparation of 2-ethylhexyl methacrylate

For the continuous preparation of 2-ethylhexyl methacrylate, 2.2 kg/h of a solution of 10% by weight of tetra-2-ethylhexyl orthotitanate (catalyst) in methyl methacrylate (2) were fed into the first segment of the reactor (7). In addition, 44 kg/h of the starting alcohol 2-ethylhexyl alcohol (1) were metered continuously into the column (6). The starting material methyl methacrylate (MMA) was introduced in a temperature-regulated manner into the segments of the reactor from the buffer vessel (13) which was charged discontinuously as required with methyl methacrylate (MMA) (11). The transesterification takes place at atmospheric pressure and boiling temperature in the reactor (6). The low-boiling by-product methanol (MeOH) formed in the reaction was removed as MMA/MeOH azeotrope at the top of the column (10). The temperatures in the reactor are prescribed as shown in the table below and are set in the individual segments by targeted introduction of MMA:

| Segment | Temperature [° C.] |
|---|---|
| 1 | 120.5 |
| 2 | 125.0 |
| 3 | 126.1 |
| 4 | 127.5 |
| 5 | 126.6 |
| 6 | 130.0 |
| 7 | 126.8 |
| 8 | 132.5 |
| 9 | 131.7 |
| 10 | 135.0 |
| 11 | 136.1 |
| 12 | 137.5 |

The resulting output stream (12) from the reactor amounted to 82 kg/h and had the following composition: 80.2% by area of 2-ethylhexyl methacrylate, 0.9% by area of 2-ethylhexyl alcohol, 18.8% by area of MMA, 0.1% by area of by-products. The space-time yield based on 2-ethylhexyl methacrylate was thus 682 kg/(m³h) at a calculated alcohol conversion of 98.3%. The selectivity based on 2-ethylhexyl alcohol was consequently almost 100%. The selectivity based on methyl methacrylate taking account of the loss of MMA via the MMA/MeOH azeotrope was likewise almost 100%.

To prevent polymerization, 0.85 l/h of stabilizer solution (1.25% by weight of hydroquinone monomethyl ether in MMA) was added continuously to the total distillate stream from the distillation column (6).

The output stream from the reactor was worked up by 2-stage distillation. The resulting end product had the following composition: 98.5% by area of 2-ethylhexyl methacrylate, 1.1% by area of 2-ethylhexyl alcohol, 0.3% by area of MMA, 0.1% by area of by-products.

### EXAMPLE 2

### Continuous Preparation of methacrylic ester 13.5 (ME-13.5) by Homogeneous Catalysis

(methacrylic ester of Neodol 25, from Shell Chemical LP)

For the continuous preparation of the methacrylic ester of Neodol 25 (ME-13.5), 2.0 kg/h of MMA/catalyst feed (2) having a tetraisopropyl orthotitanate content of 10% by weight were fed into the first segment of the reactor (7). In addition, 50 kg/h of the starting material Neodol 25 (1) were metered continuously into the lower segment of the column (6). The starting material methyl methacrylate (MMA) was fed in a temperature-regulated manner from the buffer vessel (13), which was charged discontinuously as required with “fresh” MMA (11), into the segments of the reactor. The transesterification took place at atmospheric pressure and boiling temperature in the reactor (6). The low-boiling by-product methanol (MeOH) formed in the reaction was removed as MMA/MeOH mixture (azeotrope formation) at the top of the column (10). As a result of the temperature-regulated introduction of MMA, the temperature profile indicated in the following table was established:

| Compartment | Temperature [° C.] |
|---|---|
| 1 | 110.1 |
| 2 | 119.0 |
| 3 | 120.9 |
| 4 | 120.0 |
| 5 | 124.7 |
| 6 | 125.0 |
| 7 | 126.7 |
| 8 | 130.0 |
| 9 | 133.1 |
| 10 | 135.0 |
| 11 | 136.5 |
| 12 | 139.0 |

The resulting output stream (12) from the reactor amounted to 80 kg/h and had the following composition: 83.1% by area of ME-13.5, 0.3% by area of Neodol 25, 15.2% by area of MMA, 1.4% by area of by-products (Neodol contains about 0.8% of components which cannot be reacted). The space-time yield from the reactor based on ME-13.5 was thus 665 kg/(m³h) at a calculated alcohol conversion of 99.5%. The selectivity based on Neodol 25 was consequently almost 100%. The selectivity based on methyl methacrylate taking account of the loss of MMA via the MMA/MeOH distillate was likewise almost 100%.

To prevent polymerization, 2.4 l/h of stabilizer solution (0.25% by weight of hydroquinone monomethyl ether in MMA) were added continuously to the total distillate stream from the distillation column (6).

The crude product (12) was greatly enriched in transesterification products and was subjected to a vacuum distillation (120 mbar) by means of a thin film evaporator to remove unreacted starting materials. The catalyst was precipitated from the bottom product from this distillation, which was still contaminated with catalyst and small amounts of polymerization inhibitor and high-boiling by-products, by addition of dilute sulphuric acid. The acid was then neutralized by addition of a sodium carbonate solution. In a further evaporation step, the residual MMA and the water added in the precipitation were removed under reduced pressure (120 mbar). Finally, the precipitated catalyst was removed by filtration, giving the pure product.

The resulting end product had the following composition: 97.8% by area of ME-13.5, 0.5% by area of Neodol 25, 0.1% by area of MMA, 1.6% by area of by-products (Neodol contains about 0.8% of components which cannot be reacted).

### EXAMPLE 3

### Continuous Preparation of methacrylic ester 13.5 (ME-13.5) by Heterogeneous Catalysis

(Methacrylic Ester of Neodol 25, from Shell Chemical Lp)

For the continuous preparation of the methacrylic ester of Neodol 25 (ME-13.5), 0.4 kg/h of MMA/catalyst feed (2) having a lithium hydroxide content of 2.3% by weight was fed into the first compartment of the reactor (7). In addition, 37 kg/h of the starting material Neodol 25 (1) were metered continuously into the lower segment of the column (6). The starting material methyl methacrylate (MMA) was fed in a temperature-regulated manner from the buffer vessel (13), which was charged discontinuously as required with “fresh” MMA (11), into the segments of the reactor. The transesterification took place at atmospheric pressure and boiling temperature in the reactor (6). The low-boiling by-product methanol (MeOH) formed in the reaction was removed as MMA/MeOH mixture (azeotrope formation) at the top of the column (10). As a result of the temperature-regulated introduction of MMA, the temperature profile indicated in the following table was established:

| Compartment | Temperature [° C.] |
|---|---|
| 1 | 109.9 |
| 2 | 112.9 |
| 3 | 119.6 |
| 4 | 120.1 |
| 5 | 125.4 |
| 6 | 125.0 |
| 7 | 125.1 |
| 8 | 130.0 |
| 9 | 133.8 |
| 10 | 135.0 |
| 11 | 136.5 |
| 12 | 139.0 |

The resulting output stream (12) from the reactor amounted to 59 kg/h and had the following composition: 82.9% by area of ME-13.5, 0.3% by area of Neodol 25, 15.1% by area of MMA, 1.7% by area of by-products (Neodol contains about 0.8% of components which cannot be reacted). The space-time yield from the reactor based on ME-13.5 was thus 492 kg/(m³h) at a calculated alcohol conversion of 99.5%. The selectivity based on Neodol 25 was consequently almost 100%. The selectivity based on methyl methacrylate taking account of the loss of MMA via the MMA/MeOH distillate was likewise almost 100%.

To prevent polymerization, 1.5 l/h of stabilizer solution (0.25% by weight of hydroquinone monomethyl ether in MMA) were added continuously to the total distillate stream from the distillation column (6).

The crude product was greatly enriched in transesterification products and was subjected to a vacuum distillation (120 mbar) by means of a thin film evaporator to remove unreacted starting materials. The catalyst was removed from the bottom product by filtration, giving the pure product.

The resulting end product had the following composition: 96.6% by area of ME-13.5, 0.4% by area of Neodol 25, 1.0% by area of MMA, 2.0% by area of by-products (Neodol contains about 0.8% of components which cannot be reacted).

1. Process for the continuous preparation of products from equilibrium reactions, characterized in that the starting materials are fed to a compartment reactor either via a rectification column or directly, in that the temperature is regulated by introduction of a starting material into individual segments of the compartment reactor, the reaction is accelerated, if appropriate, by the addition of catalysts and the product mixture is discharged together with unreacted starting materials and catalyst.

2. Process according to claim 1, characterized in that a product change without out-of-specification material is effected by stopping the flow of one starting material, flushing the reactor with the second starting material and subsequently changing to a new starting material.

3. Process according to claim 1, characterized in that a starting material is discharged as side stream from the rectification column and is introduced in a targeted manner into the individual segments to regulate the temperature.

4. Process for the continuous preparation of products from equilibrium reactions according to claim 1, characterized in that, for the reaction of (meth)acrylates with alcohols or amines, the starting materials are fed to a compartment reactor either via a rectification column or directly, in that the temperature is regulated via the introduction of (meth)acrylate into individual segments, the reaction is accelerated, if appropriate, by the addition of catalysts and the product mixture is discharged together with unreacted starting materials and catalyst.

5. Process according to claim 4, characterized in that a product change without out-of-specification material is effected by stopping the starting alcohol or amine flow, flushing the reactor with (meth)acrylate and subsequently changing to a new starting alcohol or a new starting amine.

6. Process according to claim 4, characterized in that (meth)acrylate is discharged as side stream from the rectification column and is introduced in a targeted manner into the individual segments to regulate the temperature.

7. Process according to claim 1, characterized in that a purification step is provided downstream.

8. Process according to claim 7, characterized in that a distillation process, filtration process or precipitation and filtration process for separating off the catalyst from the product mixture is provided downstream of the compartment reactor.

9. Process according to claim 1, characterized in that the starting materials are preheated.

10. Process according to claim 1, characterized in that unreacted starting materials are circulated.

11. Apparatus for the continuous preparation of products from equilibrium reactions, characterized in that a compartment reactor having segment walls and openings in the segment walls is divided into segments of varying size, and a rectification column via which starting materials can be introduced and also a downstream work-up step for separating off the catalyst.

12. Apparatus for the continuous preparation of products from equilibrium reactions according to claim 11, characterized in that the segment walls are provided with openings over the entire area of the metal sheets.

13. Apparatus for the continuous preparation of products from equilibrium reactions according to claim 11, characterized in that the segment walls are provided with openings in the lower third of the metal sheets.

14. (Meth)acrylates and (meth)acrylamides prepared according to claim 4, characterized in that the residual alcohol or amine content is <2%.

15. (Meth)acrylates and (meth)acrylamides prepared according to claim 4, characterized in that the residual alcohol or amine content is <0.5%.

16. (Meth)acrylates and (meth)acrylamides prepared according to claim 4, characterized in that the content of Michael addition products is <1%.

17. (Meth)acrylates and (meth)acrylamides prepared according to claim 4, characterized in that the content of Michael addition products is <0.5%.
